(19) United States
(12) Patent Application Publication
(10) Pub. No.: US 2011/0286554 A1
(43) Pub. Date: Nov. 24, 2011

(54) RF receivers

(76) Inventor: Ian KNOWLES, Burnham (GB)

(21) Appl. No.: 13/065,339

(22) Filed: Mar. 18, 2011

(30) Foreign Application Priority Data
Mar. 18, 2010 (GB) 1004561.5

(51) Int. Cl. H04L 27/06

(52) U.S. Cl. 375/340

(57) ABSTRACT

A method and apparatus are provided for receiving an RF service. At least two RF channels 26 are received. Each channel comprises a plurality of time slice services. A selected RF service is decoded from its time sliced portion with a first RF channel in a decoder 24. During periods non-intersecting with that portion of the first RF channel data from a second RF channel is decoded to determine RF services available on the second RF channel. This data is then provided for display.

### FIELD OF THE INVENTION

This invention relates to RF receivers, for example those which may receive COFDM type signals or other forms of time sliced signals.

### BACKGROUND OF THE INVENTION

The COFDM radio transmission system operates by transmitting a sequence of broad bandwidth frames of data. These frames comprise an initial header or frame information channel which includes data about the various different signals which may be decoded from a frame or ensemble. The frame further comprises a plurality of symbols, each one comprising the fast fourier transform of a set of digital carrier signals. The fast fourier transform then being modulated onto a carrier. This type of transmission is used by the Digital Audio Broadcast (DAB) radio system.

In the DAB system digital carriers are quadrature amplitude and phase modulated with the bits of digital signals from the radio stations which are to be transmitted on the DAB ensemble. Bits froth an individual radio station are distributed across a plurality of carriers and are present in different symbols within the DAB ensemble.

A DAB ensemble has a maximum amount of data it is able to carry and this is related to the maximum number of radio channels it is able to transmit, dependent on the bandwidth required for each channel. If more channels are to be transmitted than are permissible on a single DAB ensemble then further DAB ensembles are transmitted and different frequencies, i.e. there is more than one DAB channel.

In practice the DAB ensembles do not always carry the maximum number of channels of which they are capable and therefore various parts of symbols within a DAB ensemble may be unoccupied by data. Furthermore, a user of a receiver will only require data from a particular portion of each DAB symbol to enable it to decode desired radio service. It is common practice to power down a radio receiver in the portions unoccupied by data required at a receiver.

The fast information channel in a DAB ensemble includes dynamic line segment data relating to the radio channels being transmitted in that ensemble. This information can be used at a receiver and displayed so that the user may select a different radio station to play back whilst listening to an originally selected radio station before switching to the new station. In a situation where there are two DAB channels and two parallel sets of DAB ensembles being transmitted it would be desirable to be able to determine what channels are being received on the adjacent DAB channel without tuning away from a radio station currently being received. This is desirable in any multi channel system or time sliced system.

### SUMMARY OF THE INVENTION

Preferred embodiments of the present invention provide a RF receiver which is able to use portions of symbols in a current channel not used by an RF service being received to examine data in an adjacent channel to determine what information is being received in that channel.

Preferably the RF receiver is a COFDM receiver in users of portions of symbols in a current COFDM channel not used by an RF service being received to examine data in an adjacent COFDM channel to determine what information is being received on that channel.

Preferably the RF receiver is a DAB receiver and is able to use portions of COFDM symbols in a current DAB channel not used by an RF service being received to examine a fast information channel (FIC) in an adjacent DAB channel to determine what information is being received in that channel.

### BRIEF DESCRIPTION OF THE DRAWINGS

Preferred embodiments of the invention will now be described in detail by way of example with reference to the accompanying drawings in which;

FIG. 1 shows schematically the fast information channel and symbols making up a DAB frame and the portion of the symbols required to receive a selected radio channel;

FIG. 2 shows a block diagram of a prior art DAB receiver;

FIG. 2 shows a block diagram of a DAB receiver in a first embodiment of the invention;

FIG. 3 shows a block diagram of a DAB receiver in a second embodiment of the invention;

FIG. 4 shows a block diagram of a DAB receiver in a third embodiment of the invention.

FIG. 5 shows a block diagram of a DAB receiver in a fourth embodiment of the invention.

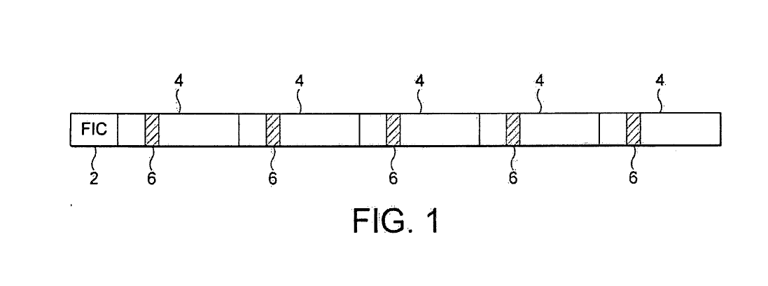

In FIG. 1 there is shown a DAB frame. Not all of the symbols in the frame are shown here, only five of these are shown but this is adequate for the purposes of illustration.

The DAB frame comprises a fast information channel (FIC) 2 at the start of the frame. This contains data pertaining to the various radio services available within the DAB frame. The DAB frame is transmitted on an RF carrier of e.g. bandwidth 10 mHz with a selected centre frequency. The DAB frame will carry a plurality of radio services. For example, in the United Kingdom, one DAB channel is used for all of the BBC radio services.

The symbols in the frame 4 are repeating symbols and each comprises the fast fourier transform of a plurality of carriers modulated with bits from the radio services they are to carry. In order to decode a selected radio service, only a portion of each symbol needs to be analysed and decoded. In this example, a portion 6 is identified in each symbol. It will be seen that this occurs at the same position in each symbol. In between, the portions 6 data is received that is of no interest to the listener. Conventionally power consumption of the receiver is decreased between reception of these portions of data. We have appreciated that this can be used to look aside at other DAB channels to determine what services are being received on them. This will involve examination of the fast information channel in another DAB channel.

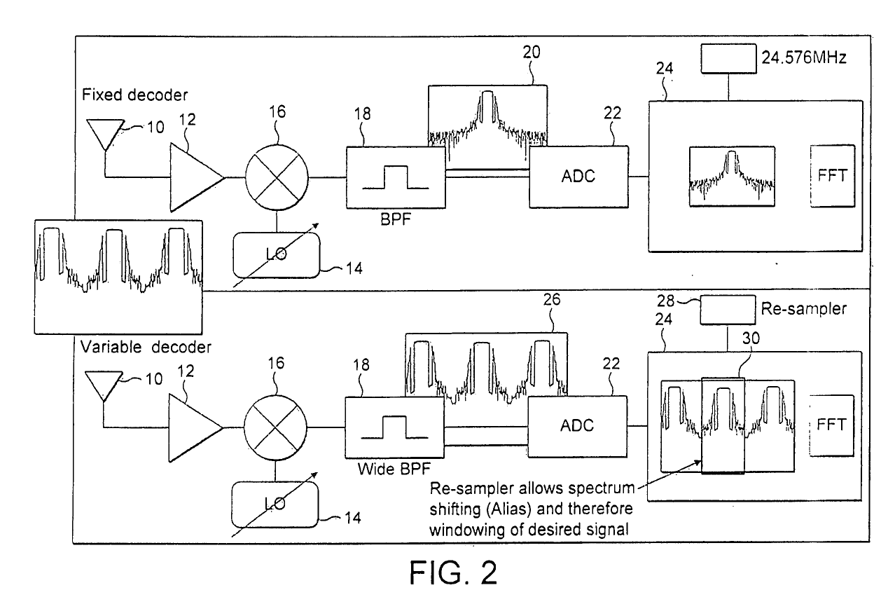

FIG. 2 shows a prior art embodiment of a DAB ensemble. An RF signal is received via an antenna 10 and amplifier 12 before being mixed with, a signal from a lower frequency oscillator 14 in mixer 16. A band pass filter 18 centred on the centre frequency of the DAB channel to be received produces an output 20 which is provided to an A to D convertor 22 and then to DAB decoder 24. The DAB decoder 24 selects the portion of the DAB ensemble 6 corresponding to the radio service a user wishes to decode and then decodes this to provide an audio output (not illustrated).

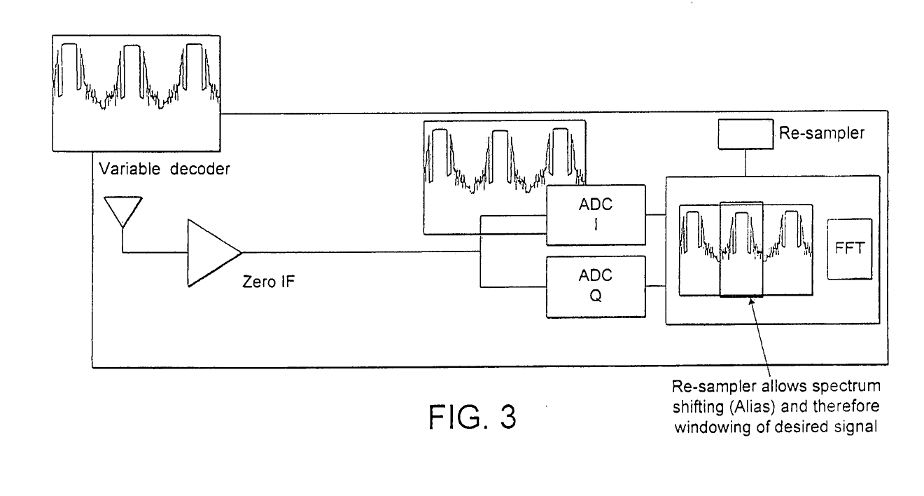

FIG. 3 shows how the circuitry of FIG. 2 is modified in an embodiment of the invention. In this example, the band pass filter 18 has a wider bandwidth so that one or more adjacent DAB ensembles are provided at its output. These pass through a A to D convertor 22 to the DAB decoder 24. A resampler 28 provides an analysis window 30 to select the desired DAB ensemble for decoding. In the illustration, the centre one of three ensembles is selected. As in FIG. 2 the segments 6 of the DAB symbols will be decoded from window 30. Thus there will be a time delay between the segments received. Typically, a DAB symbol is 24 milliseconds long and so there may be, e.g. 22 milliseconds available when no relevant data is being received.

In the time when no relevant data is being received, the resampler may control the analysis window to look at either of the adjacent DAB channels. This happens repeatedly so that over the course of a number of samples when the resampler is looking at an adjacent DAB channel it will detect the FIC 2 from that channel. This will enable the DAB decoder 24 to examine the contents of the FIC from the adjacent channel and from this it can determine the dynamic label segment data for that channel and can provide this in a display on the user's radio, as well as the dynamic label segment corresponding to the DAB channel which he is currently receiving.

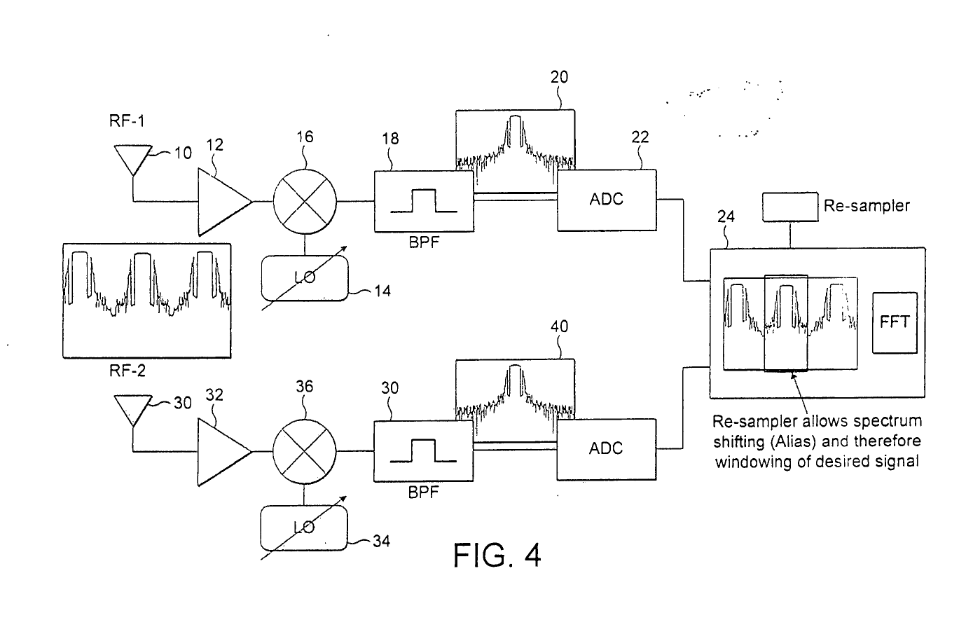

FIG. 4 shows a further modification of FIG. 3. In this, the band pass filters are removed and the signal is converted into its I and Q components (in phase and quadrature) which are both input to the DAB decoder. By doing this, the band pass filtering can be performed within the digital domain and again the resampler will control the analysis window to select the samples 6 for decoding of the desired radio service whilst looking aside to one of the other digital channels to examine its fast information channel and make that information available to the user.

FIG. 5 shows a further embodiment of the invention. In this, a second RF receiver channel is provided comprising an antenna 30, amplifier 32, local oscillator 34 and mixer 36 which provide a signal to a band pass filter 38. This band pass filter is centred on the centre frequency of a DAB channel 40 different to that of the first RF channel 20. Thus, the DAB decoder 24 is supplied with both DAB channels and can control its analysis window to look for the fast information channel received via the second RF ensemble when a desired radio service is not being decoded from the first ensemble.

Using such an arrangement also has the advantage that a radio can be set up to look for e.g. traffic reports from a corresponding radio channel, or other announcements. It might also be possible to e.g. arrange for news announcements to be received from an adjacent DAB channel whilst listening to a radio service provided on a first DAB channel using periods not required for reception of data to look at different channels being received can be used in any time sliced signal such as COFDM, DVB-H, DAB, etc.

1. A method for receiving an RF service comprising the steps of receiving at least two RF channels, each channel comprising a plurality of time sliced services, decoding a selected RF service received on a time sliced portion of a first RF channel, and during periods non intersecting with the said portion of the first RF channel decoding data available on a second RF channel to determine RF services available on the second RF channel, and providing data relating to the services provided on the second RF channel for display.

2. A method accordingly to claim 1 in which the RF channels each comprise COFDM channels.

3. A method according to claim 1 in which the RF channel comprises a DAB channel.

4. A method according to claim 2 in which the step of determining RF services available on the second RF channel comprises detecting a fast information channel (FIC) in the second RF channel.

5. Apparatus for receiving a RF service comprising means for receiving at least two RF channels, each channel comprising a plurality of time sliced services, means for decoding a selected RF service received on a time sliced portion of a first RF channel, and during periods non-intersecting with the said portion of the first RF channel, decoding data available on a second RF channel, and means for providing data relating to the services provided on the second RF channel for display.

6. Apparatus according to claim 5 in which the RF channels are COFDM channels and the decoding means is a COFDM decoder.

7. Apparatus according to claim 5 in which the RF channels are DAB channels and the decoder is a DAB decoder.

8. Apparatus according to claim 6 in which the means for determining services available on the second RF channel comprises means for detecting an FIC in the second RF channel.
